(19) United States
(12) Patent Application Publication
(10) Pub. No.: US 2012/0235828 A1
(43) Pub. Date: Sep. 20, 2012

(54) SIGNAL DEVICE

(75) Inventors: Jacek BRONOWICZ, Dorsten (DE); Bernhard ROEMER, Duisburg (DE)

(73) Assignee: FHF FUNKE + HUSTER FERNSIG GMBH, Muelheim an der Ruhr (DE)

(21) Appl. No.: 13/422,256

(22) Filed: Mar. 16, 2012

(30) Foreign Application Priority Data
Mar. 17, 2011 (DE) 20 2011 000 619.0

(51) Int. Cl. G08B 7/00

(52) U.S. Cl. 340/815.69

(57) ABSTRACT

A signal device, particularly for use in areas at risk of explosion, has a housing, at least one light source, and at least one acoustics source. A sound guidance unit follows the acoustics source with its neck opening and emits the sound produced by the acoustics source to the outside, by way of its mouth opening. The sound guidance unit not only serves to guide sound, but at the same time takes on an optical signal function.

### CROSS REFERENCE TO RELATED APPLICATIONS

Applicants claim priority under 35 U.S.C. §119 of German Application No. 20 2011 000 619.0 filed Mar. 17, 2011, the disclosure of which is incorporated by reference.

### BACKGROUND OF THE INVENTION

1. Field of the Invention

The invention relates to a signal device, particularly for use in areas at risk of explosion. The device has a housing, at least one light source, an acoustics source, and a sound guidance unit that follows the acoustics source with its neck opening and emits the sound produced by the acoustics source to the outside, by way of its mouth opening.

2. The Prior Art

A device that can fundamentally also be used as a signal device and meets the requirements indicated above is presented in DE 30 06 757 A1, which forms the type. This type involves a loudspeaker arrangement that has a loudspeaker membrane, as usual. Furthermore, an optical signal display is assigned to the loudspeaker system. The signal display is designed as a signal lamp and is placed within a sound emission surface of the related loudspeaker system, in each instance.

Aside from this sound emission surface of the loudspeaker, in the core of its membrane or spherical membrane, a sound guidance is supplementally provided, which surrounds a spherical membrane region in funnel shape. The sound guidance or sound guidance unit follows the acoustics source or the known loudspeaker system with its neck opening.

The signal lamp as such is disposed in the center region of a sound emission surface behind the sound-emitting element or the membrane, on a stationary support part. For this purpose, the membrane is structured to be at least partly transparent, so that the signal lamp is easily seen through a correspondingly configured window.

EP 1 146 280 B1 concerns itself with a signal device that works primarily acoustically, but is also equipped with a lighting means, supplementally or alternatively.

Within the scope of DE 20 2008 004 113 U1, a warning light apparatus is described, which is suitable for optical and/or acoustical warning. At this location, a special pivoting unit is implemented, which comprises at least two hollow bodies that can be fixed in place, relative to one another, in different pivot angles.

The signal devices in question are generally used in areas at risk of explosion. Only as an example, reference is made to the “Guideline 94/9/EC of the European Parliament and of the Council dated Mar. 23, 1994, for coordination of the legal provisions of the member states for devices and protective systems for use as intended in areas at risk of explosion.” There, areas at risk of explosion are defined, among other things, as areas in which the atmosphere can become explosive as the result of local and operating conditions. In particular, the components and devices must be designed so that igniting of explosive atmospheres is prevented in an individual case, taking electrical and non-electrical types of ignition sources into consideration. Furthermore, the materials used for the construction of the devices and protective systems must not bring about triggering of an explosion, taking operationally foreseeable stresses into consideration. Supplemental to these general provisions of law, it should be pointed out that such signal devices typically must demonstrate “increased safety,” as specified in greater detail in the DIN EN50019 standard, among others, now changed to DIN EN60079-7 or IEC60079-7. In any case, there are numerous such requirements that make the signal devices in question able to fulfill the purpose of use outlined.

The state of the art has fundamentally proven itself, but requires improvement as far as the general optical and acoustical warning function is concerned. This need for improvement is because up to the present, either acoustical warning signals or optical warning signals are typically produced in signal devices in areas at risk of explosion. In order to increase the warning function, however, it is often recommended to work with both optical and acoustical warning signals. The solution that forms the type at this point, in accordance with DE 30 06 757 A1, however, has the disadvantage that the light source there is detected only under an extremely limited angle of vision. This arrangement is obviously unsuited to a warning function that can be recognized all around. This situation is where the invention as a whole wishes to provide a remedy.

### SUMMARY OF THE INVENTION

It is an object of the invention to further develop such a signal device in such a manner that the acoustical and particularly the optical warning function as a whole is improved.

These and other objects are achieved according to the invention by providing a signal device of the type stated so that the sound guidance unit not only serves to guide sound that leaves the acoustics source, but at the same time takes on an optical signal function.

The sound guidance unit therefore has a dual function within the scope of the invention. For one thing, the sound guidance unit ensures that the sound produced by the acoustics source experiences an alignment along the longitudinal expanse of the sound guidance unit, and consequently the sound leaves the acoustics source or the sound guidance unit that follows it more or less targeted in a spatial direction. In this connection, the spatial direction of the spreading sound is predetermined—as usual—by the orientation of the sound guidance unit in space.

For this purpose, the sound guidance unit is typically designed in channel-like manner, with a predominantly uniform cross-section, viewed over its length. In this connection, a cylindrical pipe has proven to be particularly advantageous as a sound guidance unit. The cylindrical pipe in question normally stands on the acoustics source with its neck opening, on the foot side. In this way, the sound that normally leaves the acoustics source in a spherical wave enters directly into the neck opening of the cylindrical pipe and is then guided along the cylindrical pipe. The sound in question, guided in this manner, then leaves the cylindrical pipe on the head side, at the mouth opening, and thereby experiences rough spatial alignment, namely in the direction of the longitudinal expanse of the cylindrical pipe in question. Of course, this arrangement should be understood merely as an example and not as being compulsory.

The second function of the sound guidance unit, which specifically takes on an optical signal function, at the same time, is now of particular further importance. In other words, the sound guidance unit functions entirely or in part as an optical signal element. For this purpose, the sound guidance unit can be illuminated, in whole or in part.

In detail, it has proven to be advantageous, in this connection, if the sound guidance unit is configured to be transparent. In order to now implement the optical signal function, the sound guidance unit, which is configured to be transparent, can cover the light source or the multiple light sources that are situated behind it. Because of the transparency of the sound guidance unit, the light source or sources can easily be seen through the sound guidance unit and consequently can fulfill its/their signal function without problems. Because of the arrangement of the light source selected behind the sound guidance unit, this source simultaneously experiences protection or a protected arrangement in the interior of the sound guidance unit, which is only open in an upward direction.

Alternatively, however, the sound guidance unit can also be configured to be transparent and to function as a light conductor for the light source. In this case, the light source can be disposed, relative to the sound guidance unit, in such a manner that the light emitted by the light source is coupled into the sound guidance unit. Any scattering bodies, scattering centers, etc. situated in the sound guidance unit now ensure, in this connection, that the transparent sound guidance unit acts like a light source itself, toward the outside.

Fundamentally, of course, both these measures can be combined with one another. In other words, a light source can be provided in the interior of the transparent sound guidance unit, while a further light source is disposed on the edge side of the sound guidance unit, so that the light that leaves the light source is coupled into the sound guidance unit at its edge. In any case, the sound guidance unit takes on a dual function, as described, on the one hand in the sense of sound guidance for the sound that leaves the acoustics source, and on the other hand in the sense of the optical signal function described.

Further advantageous embodiments are described below. For example, a sound guidance unit is typically configured with rotation symmetry, for reasons of simple production. This configuration also holds true for the acoustics source. This acoustics source can be a usual loudspeaker. In this connection, the sound guidance unit and the acoustics source are normally disposed on a common axis of rotation symmetry.

In order to impart the required stability to the sound guidance unit even during robust use, for example underground, in a tunnel, etc., it has proven itself if the sound guidance unit is composed of multiple pipe shells disposed concentric to one another. These individual pipe shells can form a funnel that widens conically toward the outside, in the region of the mouth opening. As a result, the sound emission on the output side of the sound guidance unit is improved.

The light source is normally composed of multiple LEDs (light-emitting diodes). In this connection, so-called high-power LEDs have particularly proven themselves to be advantageous, in other words LEDs having a power consumption of more than 0.5 W. Such high-power LEDs are fundamentally known and are already being used to a great extent, as documented by EP 2 208 922 A1. Typically, the LEDs used according to the invention are designed in the SMD method of construction (surface-mounted device). In other words, the LEDs have a character in the nature of a small plate.

In this connection, it has proven itself if the LEDs are disposed in the interior of the sound guidance unit in the manner of a ring. In most cases, the LEDs are placed on a circle whose center coincides with the axis of rotation symmetry of the sound guidance unit. In this connection, it is recommended to dispose the LEDs or the circle described by the LEDs and a circular disk connected with this circle essentially parallel to the acoustics source and perpendicular to the axis of rotation symmetry. Furthermore, for reasons of uniform light emission, an arrangement of the LEDs having the same or predominantly the same (arc) distance relative to one another is desirable.

The LEDs can fundamentally be attached on the inside of the sound guidance unit. Alternatively or additionally, however; it is also possible to dispose the LEDs on the housing using one or more connector feet, independent of the sound guidance unit. In this case, the LEDs, on the one hand, and the sound guidance unit, on the other hand, are designed to be independent of one another, in terms of design, so that reciprocal exchange or replacement is easily possible. Assembly is also then possible in particularly simple manner, because first, the housing with the LEDs affixed to it is installed, and finally, the sound guidance unit is set on.

The housing that carries the sound guidance unit and the LEDs is generally structured in two parts. In this connection, the housing is composed of a lower part and an upper part. The lower part usually functions as a base and can be equipped with cable and line introductions. The required electrical connection is made available by way of these cable and line introductions.

In contrast, the acoustics source is provided on the upper part or is accommodated in the upper part. Furthermore, an electronic circuit for signal production is generally found in the upper part.

The upper part and the lower part can be joined with one another in any possible manner. Possibilities are engagement connections, clip connections, screw connections, etc. In this connection, it has also proven itself, on the whole, to produce not only the housing but also the sound guidance unit from plastic. Thermoplastic plastics can normally be used at this point. Of course, this embodiment should not be understood as being restrictive, because the housing can fundamentally also be produced from metal. The sound guidance unit, however, is always a transparent plastic component.

In the end result, a signal device is made available, which first of all has an excellent acoustical warning function. This excellence is because the channel-like sound guidance unit, which follows the acoustics source with its neck opening and emits the sound produced by the acoustics source to the outside by way of its mouth opening, functions similar to a known loudspeaker horn. The circumstance that the sound guidance unit has an axial length that approximately corresponds to its diameter or actually is less than its diameter contributes to this functionality. As a result, a relatively compact construction is made available, and the horn-like character is emphasized and reinforced in connection with the mouth opening, which is open essentially conically toward the outside or in the manner of a funnel.

In addition, the sound guidance unit takes on an optical signal function at the same time. Typically, the LEDs placed in the interior of the sound guidance unit, which is open in an upward direction, which are typically disposed in a circle, ensure this functionality. As a result, an optical signal effect is produced in practically all spatial directions, and this feature is of particular significance for the signal effect. The simultaneously horn-like character of the sound guidance unit furthermore ensures that the sound produced by the acoustics source is amplified. This result occurs because the sound guidance unit ensures that the tones emitted by the acoustics source are bundled and emitted in directed manner. This bundling and directed emission is done with an improved degree of efficacy. As a result, the sound guidance unit as a whole functions as a sound amplifier, which clearly improves the acoustic signal effect.

Consequently, a signal device is made available whose optical as well as acoustical signal effect is particularly great and clearly exceeds previously known constructions in terms of efficacy. All these features are possible taking into consideration a cost-advantageous structure and long-lasting function, because the LEDs used are structured to be particularly long-lived. The significant advantages can be seen in this arrangement and the results so achieved.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a perspective view of the signal device according to the invention; and

FIG. 2 is a schematic longitudinal section through the device according to FIG. 1.

### DETAILED DESCRIPTION OF PREFERRED EMBODIMENTS

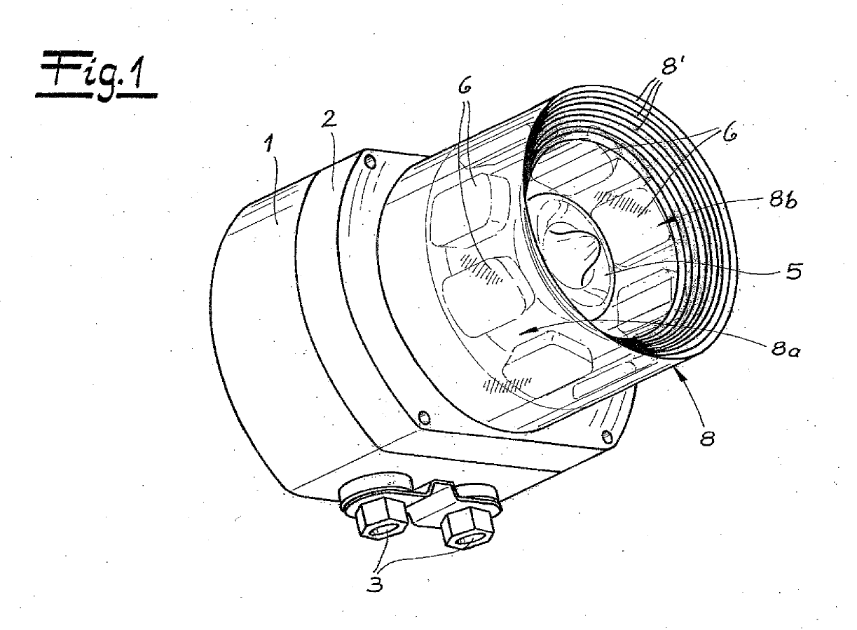

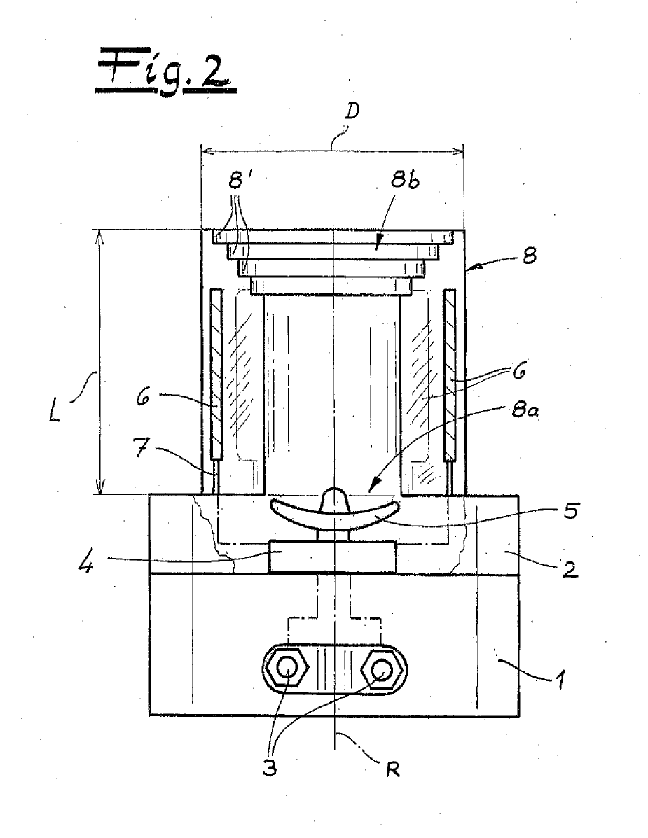

Referring now in detail to the drawings, in FIGS. 1 and 2 a signal device is shown that is particularly suitable for use in areas at risk of explosion, underground, in tunnels, etc. For this purpose, the signal device has a housing that is closed or encapsulated, as a whole, which is composed of a lower part 1 and an upper part 2 within the scope of the exemplary embodiment, without being restrictive. From the sectional representation according to FIG. 2, one can see that lower part 1 functions as the base of the housing, and is equipped with cable or line introductions 3, for example. The signal device is supplied with electrical energy and/or data by way of these cable or line introductions 3, or can supplementally or alternatively produce such data itself, as well, and send them to a remote control system.

Upper part 2 accommodates an electronic circuit 4 that is used to produce acoustical and/or optical signals. For this purpose, an acoustics source 5, which is configured as a usual loudspeaker, stands available as an acoustical converter. Acoustics source 5 is situated in upper part 2 and closes the upper part 2 off on the head side, so that the housing which is encapsulated as a whole, is formed from the two parts 1, 2. Aside from acoustics source 5, electronic circuit 4 furthermore controls a light source 6, which is composed of multiple LEDs.

The LEDs of light source 6 are power or high-power LEDs in the SMD construction, which are disposed on a circle in the manner of a ring. Connector feet 7 serve to hold the LEDs, which feet ensure not only contacting of the LEDs but also their positioning on the head of upper part 2 of the housing. Connector feet 7 can be so-called MCPCB circuit boards, in other words circuit boards having a metallic core, so-called “metal core printed circuit boards,” but this example is not a restriction.

Furthermore, a sound guidance unit 8, which is designed in channel-like or funnel-like manner and serves to amplify the sound that leaves acoustics source 5 also belongs to the further basic structure. In fact, sound guidance unit 8 follows acoustics source 5 with its neck opening 8a, and the sound produced by acoustics source 5 is emitted to the outside by way of its mouth opening 8b.

Within the scope of the invention, sound guidance unit 8 takes on a dual function. In the present case, it serves not only for guiding the sound that leaves acoustics source 5, but at the same time takes on an optical signal function. For this purpose, sound guidance unit 8 is configured to be transparent, as a whole, but it can also be designed to be only partly transparent. Sound guidance unit 8, which is structured to be transparent, covers light source 6 or the LEDs disposed in a circle. Consequently, the LEDs of light source 6 are situated in the interior of the sound guidance unit 8, in protected manner, which unit in turn is designed to be open only toward the front or on the front side. Fundamentally, sound guidance unit 8 can also function as a light conductor for light source 6. Then, light source 6 is disposed in the region of neck opening 8a, and the light that leaves light source 6 is coupled into light guidance unit 8 at the edge side. This arrangement, however, is not shown.

One can see that sound guidance unit 8 as well as acoustics source 5 are configured with rotation symmetry, in each instance. In this connection, sound guidance unit 8 and acoustics source 5 have a common axis of rotation symmetry R, in each instance. The axis of rotation symmetry R is simultaneously the axis of rotation symmetry R of the housing 1, 2, which is or can be designed with rotation symmetry relative to it, as well.

Sound guidance unit 8 is designed in channel-like or pipe-like manner, with an essentially uniform cross-section viewed over its length L. Within the scope of the exemplary embodiment, sound guidance unit 8 is a cylindrical pipe that stands on acoustics source 5 or the head-side edge of the housing 1, 2 with neck opening 8a, on its foot side.

A comparison of FIGS. 1 and 2 makes it clear that sound guidance unit 8 is composed of multiple pipe shells 8′ that are disposed concentric to one another. In this connection, the individual pipe shells 8′ are designed in such a manner, in the region of mouth opening 8b of sound guidance unit 8, that a conical opening of sound guidance unit 8 or of the cylindrical pipe implemented at this location is formed at this location. In this manner, the funnel-like character of sound guidance unit 8, in the sense of the loudspeaker horn already discussed above, is supported and emphasized.

The LEDs of light source 6 disposed on a circle, in ring-like manner, are all disposed in a common plane, whereby the center point of the circle lies on the axis of rotation symmetry R or coincides with it. This plane extends essentially perpendicular to this axis of rotation symmetry R.

The funnel-like or horn-like character of sound guidance unit 8 is supplementally furthermore emphasized because the length L of the sound guidance unit 8 essentially corresponds to its diameter D. In other words, the following applies:

L≈D

Fundamentally, however, it is also possible to work with a length L that is less than the diameter D. In this case, the following applies:

L≦D.

In any case, sound guidance unit 8 as a whole is designed to be relatively short, and, in combination with mouth opening 8b that is open conically toward the outside, ensures the desired funnel-like or horn-like character as a result of the different lengths of the individual pipe shells 8′ in the region of mouth opening 8b, and the related and desired sound amplification of the sound that leaves acoustics source 5.

Although only a few embodiments of the present invention have been shown and described, it is to be understood that many changes and modifications may be made thereunto without departing from the spirit and scope of the invention.

What is claimed is:

1. A signal device comprising:
(a) a housing;
(b) at least one light source;
(c) at least one acoustics source for producing sound; and
(d) a sound guidance unit having a neck opening following the acoustics source and a mouth opening emitting the sound produced by the acoustics source to an outside area;
wherein the sound guidance unit simultaneously serves to guide sound and to function as an optical signal.

2. The signal device according to claim 1, wherein the sound guidance unit is transparent and the at least one light source is situated behind and covered by the sound guidance unit.

3. The signal device according to claim 1, wherein the sound guidance unit is transparent and functions as a light conductor for the at least one light source.

4. The signal device according to claim 1, wherein each of the sound guidance unit and the at least one acoustics source is configured to have rotation symmetry.

5. The signal device according to claim 4, wherein the sound guidance unit and the at least one acoustics source are disposed on a common axis of rotation symmetry.

6. The signal device according to claim 1, wherein the sound guidance unit has a channel shape with a length and a predominantly uniform cross-section viewed over the length.

7. The signal device according to claim 1, wherein the sound guidance unit comprises a cylindrical pipe having a foot side that stands on the at least one acoustics source with the neck opening being located on the foot side.

8. The signal device according to claim 1, wherein the sound guidance unit is composed of a plurality of pipe shells disposed concentrically to one another.

9. The signal device according to claim 5, wherein the at least one light source is composed of a plurality of light-emitting diodes.

10. The signal device according to claim 9, wherein the light-emitting diodes are arranged in a ring inside the sound guidance unit.

11. The signal device according to claim 9, wherein the light-emitting diodes are arranged in a circle whose center coincides with the axis of rotation symmetry of the sound guidance unit.

12. The signal device according to claim 9, wherein the light-emitting diodes are attached to an inside portion of the sound guidance unit.

13. The signal device according to claim 9, further comprising at least one connector foot, the light-emitting diodes being disposed on the housing via the at least one connector foot independently of the sound guidance unit.

14. The signal device according to claim 9, wherein the light-emitting diodes are high-power LEDs.

15. The signal device according to claim 14, wherein the high-power LEDs are designed as surface mounted devices.

16. The signal device according to claim 1, wherein the housing comprises a lower part functioning as a base and an upper part that accommodates the at least one acoustics source.
